(19) United States
(12) Patent Application Publication
(10) Pub. No.: US 2026/0064130 A1
(43) Pub. Date: Mar. 5, 2026

(54) COOPERATIVE DECONFLICTION SYSTEM FOR LOW-MANEUVERABILITY AIRCRAFT

(71) Applicant: Richard Joseph Mitchell, TAVARES, FL (US)

(72) Inventor: Richard Joseph Mitchell, TAVARES, FL (US)

(21) Appl. No.: 19/383,652

(22) Filed: Nov. 8, 2025

(51) Int. Cl. G05D 1/633; B64B 1/40; B64F 5/60; G05D 1/644; G05D 109/20; G08G 5/80

(52) U.S. Cl. CPC G05D 1/633; B64B 1/40; B64F 5/60; G05D 1/644; G08G 5/80; G05D 2109/20

(57) ABSTRACT

A system for safe, autonomous deconfliction of an Unmanned Aerial System (UAS) from a low-maneuverability aircraft (LMA), such as a hot air balloon. The system includes a multi-sensor fusion module for cross-modal classification of the LMA; a specialized Intent Prediction Module that generates a three-dimensional Cone of Probability (C) for the LMA's future trajectory based on real-time meteorological data (W); and a Prognostic-Informed AI Control (PI-AIC) module. The PI-AIC module calculates an optimal avoidance trajectory (Tₒₚₜ) by minimizing a multi-objective cost function (J) that heavily penalizes intersection with C. Crucially, the optimization is subject to a Prognostic Health Constraint (PHC) requiring the maneuver to be achievable without compromising the predicted Remaining Useful Life (RUL) or Remaining Battery Capacity (RBC) of the host UAS below a predetermined Safety Margin (Sₘ).

### BACKGROUND OF THE INVENTION

### 1. Technical Field

The present invention relates generally to autonomous navigation systems, and more specifically to systems and methods for Detect-and-Avoid (DAA) functionality in Unmanned Aerial Systems (UAS) operating near low-maneuverability aircraft (LMA), where the threat trajectory is determined by external meteorological forces.

### 2. Background Art

Conventional Detect-and-Avoid (DAA) systems rely on kinematic models (e.g., constant velocity or constant acceleration) to predict the future position of airborne traffic. These models are effective for actively powered and highly controllable aircraft (e.g., manned aircraft, fixed-wing UAS, helicopters). However, low-maneuverability aircraft, notably hot air balloons, present a unique challenge because their trajectory is passive and primarily governed by unmodeled or semi-modeled environmental factors, specifically wind vectors (W). Applying standard kinematic models to such aircraft results in poor trajectory prediction accuracy, leading to suboptimal or overly aggressive avoidance maneuvers by the host UAS, which creates an unaddressed safety gap.

Furthermore, known DAA systems focus exclusively on external collision risk but fail to integrate the host vehicle's internal health status (Prognostic Health Monitoring, or PHM) into the avoidance calculation, risking mission failure or component damage for an avoidance maneuver that, while externally safe, is internally taxing. The conventional approach is insufficient for safe, long-term autonomous operations where component over-stress or power depletion caused by an aggressive maneuver can lead to mission failure or a crash.

### BRIEF SUMMARY OF THE INVENTION

The invention overcomes the limitations of the prior art by providing an integrated, AI-driven Cooperative Deconfliction System (CDS) that effectively manages deconfliction with wind-governed aircraft. The system is installed onboard a host UAS and employs a synergistic, three-step process:

1. Classification: Using a Cross-Modal Geometric Validation (CMGV) pipeline to reliably identify the detected object as a low-maneuverability aircraft (e.g., hot air balloon) based on fused sensor data (e.g., LiDAR geometry and thermal signature).

2. Prediction: Utilizing a specialized Intent Prediction Module that incorporates real-time wind vector data (W) and the aircraft's aerodynamic model (Aₐₑᵣₒ) to compute a high-fidelity, probabilistic future path, represented as a Cone of Probability (C).

3. Avoidance Planning: Employing a Prognostic-Informed AI Control (PI-AIC) module to formulate an optimal avoidance trajectory (Tₒₚₜ) by solving a multi-objective optimization problem. This problem is uniquely constrained by the host UAS's current prognostic health status, specifically Remaining Useful Life (RUL) and Remaining Battery Capacity (RBC), ensuring the selected maneuver is both collision-free and survivable for the host UAS.

### BRIEF DESCRIPTION OF THE SEVERAL VIEWS OF THE DRAWING

FIG. 1 is a block diagram illustrating the overall architecture of the Cooperative Deconfliction System (CDS) and its integration with the host UAS subsystems.

FIG. 2 is a schematic diagram illustrating the inputs and outputs of the Intent Prediction Module for generating the three-dimensional Cone of Probability (C) based on wind vector data (W).

FIG. 3 is a flow chart detailing the operation of the Prognostic-Informed AI Control (PI-AIC) module, showing the incorporation of the Prognostic Health Constraint into the multi-objective optimization process.

### DETAILED DESCRIPTION OF THE INVENTION

### System Architecture

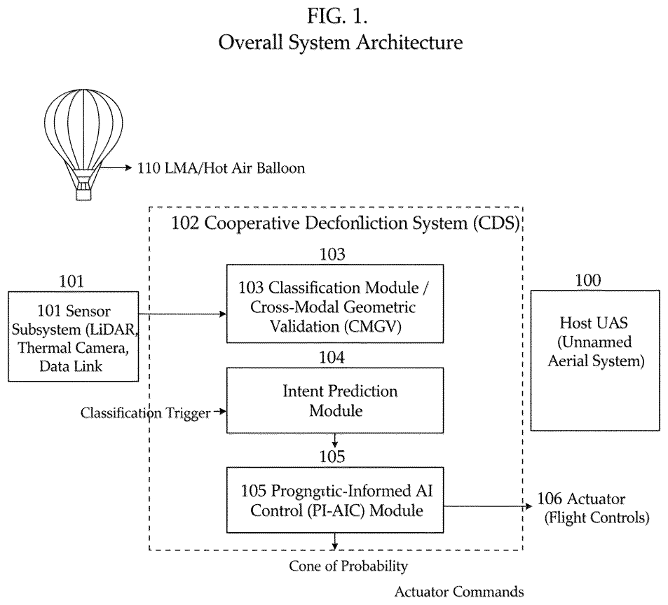

The Cooperative Deconfliction System (CDS) is a hardware and software solution implemented within a host Unmanned Aerial System (UAS). As shown in FIG. 1, the CDS utilizes the following subsystems:
ensor Subsystem: A suite of sensors including, but not limited to, LiDAR for generating high-fidelity three-dimensional point clouds, a thermal camera for heat signature analysis, and an interface (e.g., an on-board anemometer or a high-bandwidth data link) for receiving real-time, altitude-layered wind vector data (W).
Processing Unit: A dedicated, ruggedized AI accelerator or flight controller capable of running machine learning and complex optimization algorithms with low latency.
Actuator Subsystem: The flight control system responsible for executing the commands generated by the CDS to perform the calculated avoidance maneuver.

### Cross-Modal Detection and Classification

The inventive process begins with the Cross-Modal Geometric Validation (CMGV) pipeline (FIG. 1, Block A). This pipeline achieves a high-confidence classification of the threat by fusing data from disparate sensors, which is necessary to correctly identify the object as a low-maneuverability aircraft whose movement must be predicted using the specialized meteorological model.

For the specific embodiment of a hot air balloon, the system requires a simultaneous match on two distinct criteria to classify the object as such:
a) Geometric Criterion: LiDAR data is processed to confirm the presence of a distinct, large, generally spherical or teardrop-shaped envelope structure.
b) Thermal Criterion: Thermal imaging data must confirm a characteristic high-temperature signature (e.g., a concentrated heat plume or hot-spot) consistent with a balloon's burner apparatus, localized beneath the envelope structure.

This reliable classification step triggers the activation of the specialized Intent Prediction Module.

While the embodiment of a hot air balloon is described using LiDAR and thermal sensors, it is to be understood that the CMGV pipeline may be adapted for other LMAs using various sensor modalities. For example, an unpowered glider or sailplane, which is also an LMA, might be classified by fusing LiDAR-derived geometry (long, thin wing and fuselage structure) with the absence of a thermal signature consistent with an engine. Other LMAs, such as parasails or unpowered drones, may be classified using different fused sensor logic, such as combinations of radar cross-section, acoustic signatures, or visual-based shape recognition processing.

### Intent Prediction Module

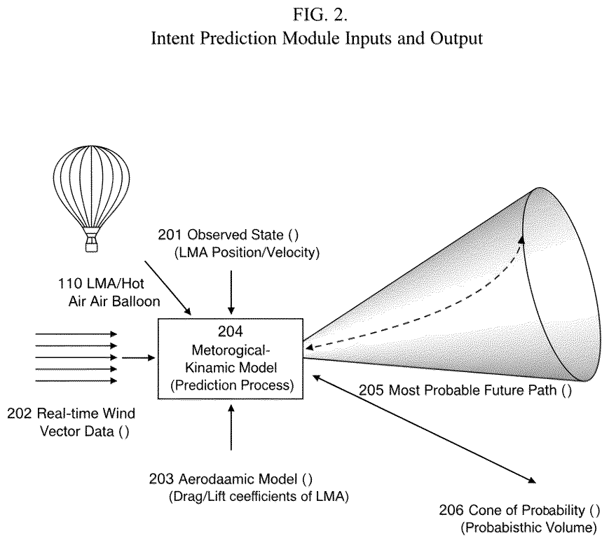

Once the threat is classified as a low-maneuverability, wind-governed aircraft, the specialized Intent Prediction Module is activated (FIG. 1, Block B), replacing conventional kinematic prediction. As shown in FIG. 2, the module receives:
4. Observed position, velocity, and altitude of the balloon (X_{obs}).
5. Real-time wind vector data (W) across relevant altitude layers.
6. A parameterized model of the hot air balloon's aerodynamic properties, including drag and lift coefficients (Aₐₑᵣₒ).

The module computes the balloon's most probable future path (P) over a defined time horizon (ΔT) using a meteorological-kinematic model.

The critical output is a three-dimensional Cone of Probability (C). The C is a mathematically defined volume of airspace that represents the probability distribution of the balloon's location throughout the time horizon ΔT. The volume and density of C are directly influenced by the spatial and temporal variability (i.e., the uncertainty) of the input wind vectors (W) and the observed uncertainty in the balloon's current state (X_{obs}). This quantification of risk allows the control system to avoid the probabilistic hazard volume rather than just a deterministic, potentially inaccurate, point prediction.

To further satisfy the enablement requirement of 35 U.S.C. § 112(a), the meteorological-kinematic model may be implemented, for example, by propagating the LMA's state forward in time using a physics-based model. An exemplary, non-limiting model may be expressed as:

$${P}_{future} = {P}_{current} + ( {W}_{vector} \cdot Δ T ) + ( f ( {A}_{aero \_ drag} ) \cdot Δ {T}^{2} )$$

where the uncertainty in W_{vector} and Aₐₑᵣₒ directly informs the volume and divergence of the resulting Cone of Probability C.

### Health-Informed Avoidance Planning

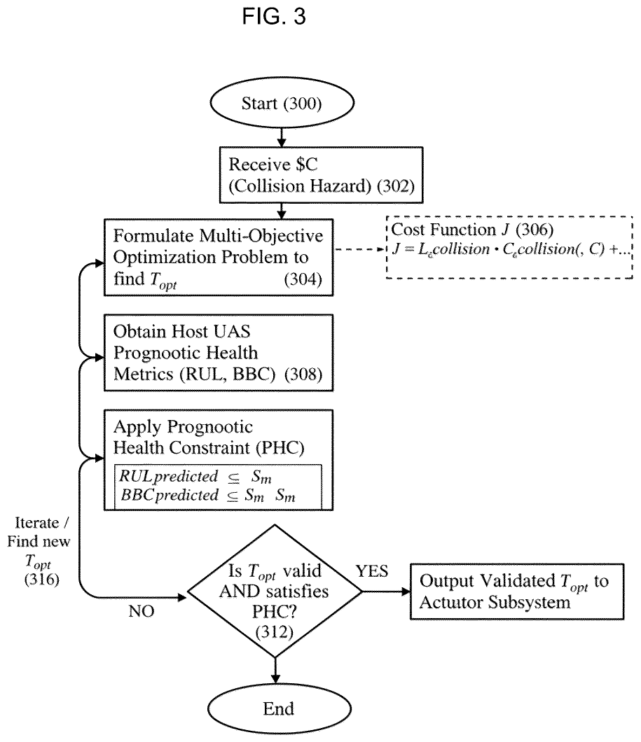

The predicted collision hazard (C) is passed to the Prognostic-Informed AI Control (PI-AIC) module (FIG. 1, Block C). As detailed in the flow chart of FIG. 3, the PI-AIC module formulates a constrained multi-objective optimization problem to determine the optimal avoidance trajectory (Tₒₚₜ) for the host UAS.

The PI-AIC module seeks to minimize a Cost Function ( ), which is defined to prioritize collision avoidance while maintaining efficiency:

$$J = {L}_{collision} \cdot {C}_{collision} ( T , C ) + {L}_{energy} \cdot {C}_{energy} ( T ) + {L}_{time} \cdot {C}_{time} ( T )$$

Where:
   C_{collision} represents the risk of intersection between the host UAS's potential trajectory (T) and the balloon's probability cone (C).
   The weighting factor L_{collision} is assigned a value significantly higher than L_{energy} and Lₜᵢₘₑ to ensure collision risk minimization is the dominant objective.
   C_{energy} and Cₜᵢₘₑ represent the costs associated with the required energy consumption and the time required to achieve safe separation, respectively.

Prognostic Health Constraint (PHC): Crucially, the optimization is subject to the Prognostic Health Constraint. The module interacts with a prognostic health monitoring (PHM) subsystem to obtain real-time health metrics of the host UAS, including: Remaining Useful Life (RUL) of critical components and Remaining Battery Capacity (RBC).

The PHM subsystem utilizes a predictive model that estimates the transient change in component degradation and energy draw resulting from executing the specific, high-stress load of the hypothetical maneuver Tₒₚₜ. This predictive calculation of the instantaneous load, which differs from traditional long-term PHM forecasting, feeds the constraint.

The optimal trajectory (Tₒₚₜ) is only considered feasible if its execution maintains the predicted health metrics above a predetermined, application-specific Safety Margin (Sₘ). The constraint is mathematically expressed as:

$${RUL}_{predicted} \geq {S}_{m} AND {RBC}_{predicted} \geq {S}_{m}$$

Exemplary Sₘ Calculation: To satisfy enablement (35 U.S.C. § 112(a)), the Safety Margin (Sₘ) determination must be defined relative to the mission objectives. For RBC, Sₘ may be set to guarantee a 10% reserve capacity post-maneuver, ensuring sufficient power remains for routine operations or diversion. For RUL, Sₘ is calculated to ensure the predicted life consumption from the high-stress maneuver does not drop the component's expected remaining life below the minimum required to safely complete the current mission or return to a designated recovery location.

This novel constraint prevents the selection of an externally safe maneuver that would necessitate an energy expenditure or component stress level leading to a high probability of internal UAS failure, thereby ensuring long-term operational survivability.

What is claimed is:

1. A system for deconfliction of an Unmanned Aerial System (UAS) with a low-maneuverability aircraft (LMA), the system comprising:
a. A sensor subsystem comprising a LiDAR sensor, a thermal camera, and an interface for receiving real-time wind vector data (W); A classification module configured to process fused data from the LiDAR sensor and the thermal camera using a Cross-Modal Geometric Validation (CMGV) pipeline to classify an airborne object as an LMA having characteristics of a hot air balloon by confirming geometric and thermal signatures;
b. An Intent Prediction Module responsive to the classification module, configured to:
i. Receive the classified aircraft's observed state (X_{obs}) and the real-time wind vector data (W); Employ a meteorological-kinematic model to compute the aircraft's most probable future path (P) over a time horizon (ΔT); and
ii. Generate a three-dimensional Cone of Probability (C) representing the probabilistic spatial occupancy of the aircraft throughout ΔT; and
c. A Prognostic-Informed AI Control (PI-AIC) module configured to:
i. Receive the C; Formulate a multi-objective optimization problem to determine an optimal avoidance trajectory (Tₒₚₜ) for the UAS by minimizing a cost function (J) where a collision risk term (C_{collision}) is assigned a dominant weight (L_{collision}); Subject the optimization to a Prognostic Health Constraint that requires the execution of Tₒₚₜ to maintain the host UAS's prognostic health metrics, including Remaining Useful Life (RUL) and Remaining Battery Capacity (RBC), above a predetermined Safety Margin (Sₘ), wherein the RUL and RBC are predicted based on the transient stress load and energy consumption resulting from the execution of the proposed Tₒₚₜ; and
ii. Output actuator commands corresponding to the validated Tₒₚₜ.

2. The system of claim 1, wherein the Cross-Modal Geometric Validation (CMGV) pipeline confirms the classification of the hot air balloon by matching a distinct, large, generally spherical or teardrop geometry from the LiDAR sensor with a characteristic high-temperature signature consistent with a burner apparatus from the thermal camera.

3. The system of claim 1, wherein the Intent Prediction Module further inputs a parameterized model of the hot air balloon's aerodynamic drag and lift coefficients (Aₐₑᵣₒ) into the meteorological-kinematic model.

4. The system of claim 1, wherein the cost function (J) is defined as:
$$J = {L}_{collision} \cdot {C}_{collision} ( T , C ) + {L}_{energy} \cdot {C}_{energy} ( T ) + {L}_{time} \cdot {C}_{time} ( T )$$
where L_{collision} is substantially greater than L_{energy} and Lₜᵢₘₑ.

5. The system of claim 1, wherein the Safety Margin (Sₘ) for the Remaining Battery Capacity (RBC) is calculated to ensure a minimum reserve capacity is maintained upon completion of the Tₒₚₜ.

6. The system of claim 1, wherein the Prognostic Health Constraint is mathematically expressed as:
$${RUL}_{predicted} \geq {S}_{m} AND {RBC}_{predicted} \geq {S}_{m} .$$

7. A method for autonomous deconfliction of an Unmanned Aerial System (UAS) from a low-maneuverability aircraft (LMA), comprising the steps of:
a. Classifying the LMA using a multi-sensor fusion process, the classification including a Cross-Modal Geometric Validation (CMGV) of LiDAR data and thermal data to identify the aircraft as having characteristics of a hot air balloon;
b. Predicting the aircraft's future path by:
i. Receiving real-time wind vector data (W);
ii. Calculating the aircraft's most probable future path (P) based on a meteorological-kinematic model and the W; and
iii. Generating a three-dimensional Cone of Probability (C) that defines the spatial probability of the aircraft's location over a time horizon (ΔT);
c. Evaluating the host UAS's prognostic health status, including Remaining Useful Life (RUL) of critical components;
d. Formulating a multi-objective optimization problem to determine an optimal avoidance trajectory (Tₒₚₜ) that minimizes a cost function (J) heavily weighted toward avoiding intersection with C;
e. Constraining the optimization problem using a Prognostic Health Constraint that requires the execution of Tₒₚₜ to maintain the UAS's RUL and RBC above a predetermined Safety Margin (Sₘ), wherein the RUL and RBC are predicted based on the transient stress load and energy consumption resulting from the execution of the proposed Tₒₚₜ; and
f. Executing the resulting constrained optimal avoidance trajectory (Tₒₚₜ).

8. The method of claim 7, wherein the Prognostic Health Constraint is calculated to ensure the predicted life consumption from the execution of Tₒₚₜ does not render the host UAS incapable of safely completing the current mission.

9. The method of claim 7, wherein the classifying step includes confirming a spherical or teardrop geometry derived from LiDAR and a concentrated heat plume derived from the thermal data.

10. The method of claim 7, wherein the predicting step uses an aerodynamic model of the hot air balloon to refine the calculation of P.

11. A system for autonomous trajectory control of a host vehicle, the system comprising a control module, implemented in a processing unit, configured to:
a. receive a predicted hazard volume representing a spatial region to be avoided;
b. formulate an optimization problem to determine a hypothetical avoidance trajectory (Tₒₚₜ) to navigate the host vehicle around said predicted hazard volume;
c. interact with a prognostic health monitoring (PHM) subsystem to obtain a predicted transient load on the host vehicle resulting from a hypothetical execution of said Tₒₚₜ, said predicted transient load including at least one of a predicted Remaining Useful Life (RUL) or a predicted Remaining Battery Capacity (RBC);
d. subject the optimization problem to a Prognostic Health Constraint (PHC) that validates said Tₒₚₜ as feasible only if said predicted RUL and predicted RBC remain above a predetermined Safety Margin (Sₘ) post-execution of said Tₒₚₜ; and
e. output actuator commands corresponding to said Tₒₚₜ only if said Tₒₚₜ satisfies the PHC.

12. A method for autonomous trajectory control of a host vehicle, the method comprising:
a. receiving, at a processing unit, a predicted hazard volume representing a spatial region to be avoided;
b. formulating, by the processing unit, an optimization problem to determine a hypothetical avoidance trajectory (Tₒₚₜ) to navigate the host vehicle around said predicted hazard volume;
c. obtaining, by the processing unit, a predicted transient load on the host vehicle resulting from a hypothetical execution of said Tₒₚₜ, said predicted transient load including at least one of a predicted Remaining Useful Life (RUL) or a predicted Remaining Battery Capacity (RBC);
d. subjecting, by the processing unit, the optimization problem to a Prognostic Health Constraint (PHC) that validates said Tₒₚₜ as feasible only if said predicted RUL and predicted RBC remain above a predetermined Safety Margin (Sₘ) post-execution of said Tₒₚₜ; and
e. outputting actuator commands corresponding to said Tₒₚₜ only if said Tₒₚₜ satisfies the PHC.

13. A non-transitory computer-readable medium storing instructions which, when executed by a processing unit of a host vehicle, cause the processing unit to perform a method for autonomous trajectory control, the method comprising:
a. receiving a predicted hazard volume representing a spatial region to be avoided;
b. formulating an optimization problem to determine a hypothetical avoidance trajectory (Tₒₚₜ) to navigate the host vehicle around said predicted hazard volume;
c. obtaining a predicted transient load on the host vehicle resulting from a hypothetical execution of said Tₒₚₜ, said predicted transient load including at least one of a predicted Remaining Useful Life (RUL) or a predicted Remaining Battery Capacity (RBC);
d. subjecting the optimization problem to a Prognostic Health Constraint (PHC) that validates said Tₒₚₜ as feasible only if said predicted RUL and predicted RBC remain above a predetermined Safety Margin (Sₘ) post-execution of said Tₒₚₜ; and
e. outputting actuator commands corresponding to said Tₒₚₜ only if said Tₒₚₜ satisfies the PHC.
